(19) United States
(12) Patent Application Publication
(10) Pub. No.: US 2007/0187602 A1
(43) Pub. Date: Aug. 16, 2007

(54) Circuit and method for reading out electric signals from a high-resolution thermal sensors

(76) Inventors: Christian Wennmacher, Hoechstadt (DE); Reinhard Mikuta, Schoenebeck (DE); Edmund P. Burte, Neudrossenfeld (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/557,465

(22) PCT Filed: May 21, 2004
(86) PCT No.: PCT/DE04/01063

§ 371 Date: Jan. 18, 2007

(30) Foreign Application Priority Data
May 21, 2003 (DE) 103 22 860.8

(51) Int. Cl. G01J 5/00

(52) U.S. Cl. 250/338.1

(57) ABSTRACT

The invention relates to a circuit array for the reading out of electronic signals (t₁, t₄) from high-resolution thermal sensors (1′, 1*) with small signals and small signal dynamics which permits an interference-free reading out of individual elements from a larger sensor array. The invention relates to a circuit array for the interference-free reading out of electronic signals of individual elements of high-resolution arrays of thermal sensors (1′, 1*) such as thermocouples, thermopiles, pyrometers and bolometers.

A circuit array for reading out electronic signals from high-resolution thermal sensors with small signals and small signal dynamics is indicated which permits an interference-free reading out of individual elements of a larger sensor array.

The invention also relates to a circuit array for the interference-free reading out of electronic signals of individual elements of high-resolution arrays of thermal sensors such as thermocouples, thermopiles, pyrometers and bolometers, and also to one or several corresponding processes.

High-resolution sensors with a large number of individual elements are used in many fields. The number of the individual elements can greatly vary and, nowadays, ranges typically from a few dozens to a few millions (megapixel sensors). As a rule, a parallel reading out of such an amount of data channels is not feasible, since the number of the connections should then be equal to the number of the individual elements. Instead, the sensor signals are serially read out by means of a multiplexer via one or a few data lines. Here, the multiplexer is integrated in the array of individual sensors. In the case of interference-prone sensors one amplifier per data line is still connected downstream of the multiplexer in some cases. The prior art is e.g. represented by 256-Pixel CMOS-INTEGRATED THERMOELECTRIC INFRARED SENSOR ARRAY by A. Schaufelbuehl et al., Proc. MEMS (2001), Interlaken, Switzerland, Jan. 21-25, (2001), pp. 200-203. In the case of very small signals and in particular those with relative small signal dynamics there may be considerable interferences during the reading out, in particular also caused by the multiplexer itself. A typical example of this are integrated arrays of thermopile arrays, in which, due to the high internal resistance, only very small currents flow which are very interference-prone.

It is the object of the invention to reduce the interference proneness of thermal sensors with a large number of individual elements, i.e. to increase the resolution while reducing the size of the individual element; in particular, the quality of high-resolution thermal sensors is to be improved.

According to the invention the object is attained by means of a circuit array consisting of a plurality of thermal sensor elements, at least one multiplexer and amplifiers, the signals of a plurality of individual thermal sensors being serially read out by means of a multiplexer via one or a few data lines, an amplifier being in each case connected between each individual thermal sensor element and the multiplexer (claim 1, claim 10).

The amplifiers are preferably designed as semiconductor devices so that they can be produced in an integrated fashion with the same manufacturing steps as the sensors. The amplifiers may be designed as operational amplifiers, differential amplifiers or also as impedance converters. These amplifiers may optionally be cyclically switched on and switched off to reduce the thermal load (claim 2).

The process of the working method of the pixel sensor array is covered by claim 9.

The invention is explained and supplemented by means of examples, it being pointed out that the following representation is a description of a preferred example of the invention.

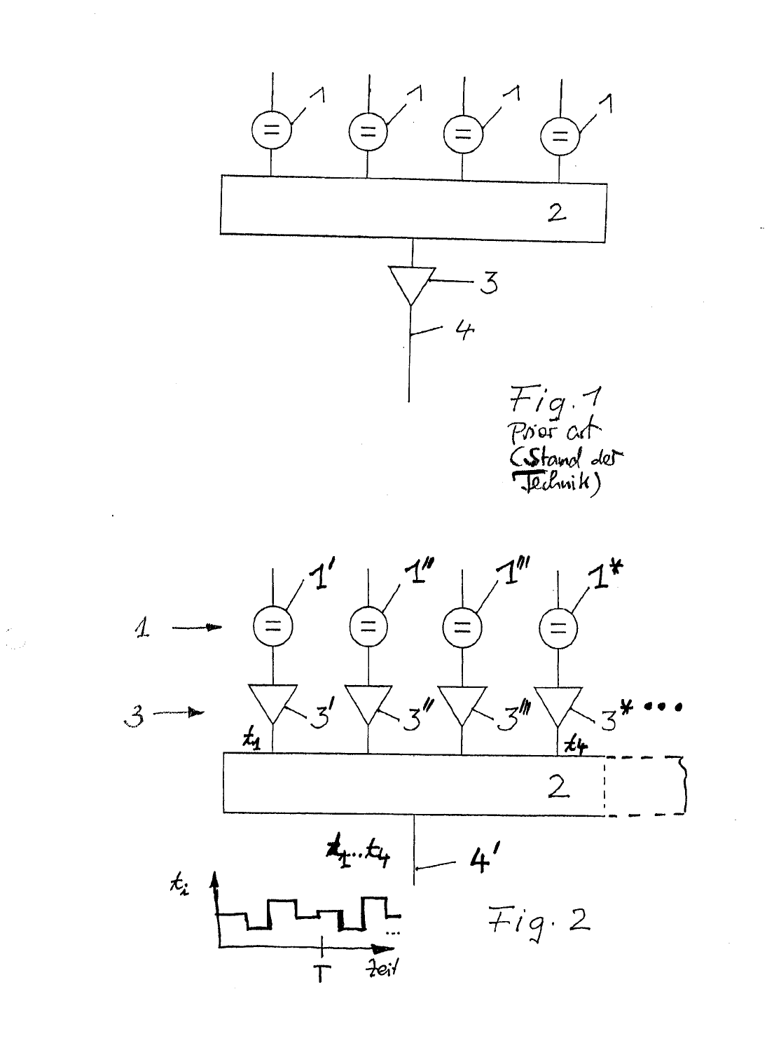

FIGS. 1 and 2 serve for the further explanation of the circuit array according to the invention.

The circuit array according to FIG. 1 that has been customary so far is compared with that according to the invention in FIG. 2.

FIG. 1 shows a known circuit array for the reading out of electronic signals from thermal sensors.

FIG. 2 is an example of a design of such an array according to the invention.

Thermal sensor elements are denoted with the reference numeral 1, a plurality of which are provided. In the example of FIG. 2 four such thermal sensors 1 are shown. They work towards a multiplexer 2 which receives the signals from all thermal sensors and emits them to a (multiplexed) data line 4′. An amplifier 3 is in each case connected between each thermal sensor element 1 and the multiplexer 2.

Each channel is described in accordance with FIG. 2 in such a way that there is the same array. The first channel has a first thermal sensor 1′, which works towards a first amplifier 3′, which supplies the multiplexer at one of its inputs—appropriately the first one. The second channel has a second thermal sensor 1″ and a second amplifier 3−, which supplies the second input of the multiplexer. The third channel has a third thermal sensor 1′″ and an amplifier 3′″ of its own which supplies the third input of the multiplexer 2. A fourth channel has a fourth thermal sensor 1* which supplies a fourth amplifier 3* which supplies the fourth input of the multiplexer 2. The array is optionally expandable or reducible as long as at least two thermal sensors are present and thus more than one. The number of the thermal sensors which can be connected as a maximum depends on the number of the inputs of the multiplexer 2.

The data output 4′ of the multiplexer emits, nested in terms of time, the several input signals which are applied to the several inputs of the multiplexer, in this case four.

In order to illustrate the signal path, the thermal signals t₁ to t₄ are indicated at the input. They can be read in a multiplexed fashion at the output 4′ in a time-resolved manner and are further transmitted.

The thermal sensors are high-resolution thermal sensors with small signals and small signal dynamics. An interference-free reading out of these individual elements from a larger sensor array is permitted.

The circuit array permits the interference-free reading out of the signals of the individual elements which jointly form a high-resolution array of thermal sensors. Thermocouples, thermopiles, pyrometers and bolometers come into consideration as thermal sensors. The reference numerals 1′ to 1* are representative of the one or the other of said high-resolution thermal sensors.

Means are provided by means of which the amplifiers 3′ to 3* are cyclically switched on and off to reduce the thermal load.

Operational amplifiers, differential amplifiers or impedance converters come into consideration as amplifiers.

Preferably, the circuit as an array is produced in CMOS technology, namely as an integrated circuit. The number of the individual elements varies greatly and typically ranges from a few dozen to a few million sensors (megapixel sensors). A parallel reading out of such an amount of data channels takes place via the multiplexer 2. A plurallity of the one circuit array shown may be disposed in an integrated fashion in the IC so that there is not only one output signal 4′, but a few more, which, however—as compared with the number of the input channels—are still only “a few” data lines. The multiplexer 2 is integrated in the array of the individual sensors.

The amplifiers are preferably designed as semiconductor devices and they are produced with the same manufacturing steps with which the thermal sensors 1′ to 1* are manufactured. The switching off of the amplifiers 3′ to 3* is graphically not shown, but readily understandable for a person skilled in the art from the context and the circuit array even without a graphic representation. The cyclic switching on and switching off of the amplifiers is e.g. effected by means of separate inputs. Thus, the thermal load is reduced.

In FIG. 2 the multiplexer 2 at the right-hand margin illustrates that the four input channels represented by way of example may only be the beginning of a large plurality of input channels working towards the same multiplexer. 256 pixels may e.g. be selected which relate to a multiplexer with an 8-bit control input for the selection of the channels 1 to 255. Here, a person skilled in the art does not have that many indices superscript at his disposal that they could all be used for the unequivocal characterization of each individual amplifier 3 and, on the other hand, the width of the sheet is limited. Consequently, only a few of a plurality of thermal elements from an array are represented.

### LIST OF REFERENCE NUMERALS

1: thermal sensor elements

2: multiplexer

3: amplifier

4: data output

We claim:

1. An array for reading out electronic signals (t₁, t₄) from high-resolution thermal sensors, having a plurality of thermal sensor elements (1′,1*), at least one multiplexer (2) and amplifiers (3′,3*), the signals of the plurality of sensor elements being serially read out by means of multiplexers via at least one data line (4′), an amplifier (3′,3*) each being connected between each individual thermal sensor element (1′,1*) and the multiplexer (2).

2. The array according to claim 1, wherein the amplifiers are cyclically switched on and switched off to reduce the thermal load, in particular by means of means in the circuit.

3. The array according to claim 1 or 2, wherein the amplifiers are operational amplifiers.

4. The array according to claim 1 or 2, wherein the amplifiers are differential amplifiers.

5. The array according to claim 1 or 2, wherein the amplifiers are impedance converters.

6. The array according to claim 1 or 2, wherein the circuit array is produced in an integrated fashion in CMOS technology.

7. The array according to claim 1, wherein it in its capacity as an array has more than “a few dozens” of sensor elements.

8. The array according to claim 7, wherein a few million sensors (1′,1*) and a few multiplexers (2) are provided.

9. A process for reading out electronic signals (t₁, t₄) from high-resolution thermal sensors, having a plurality of thermal sensor elements (1′,1*), at least one multiplexer (2) and amplifiers (3′,3*), the signals of the plurality of sensor elements being serially read out by means of multiplexers via at least one data line (4′), an amplifier (3′,3*) each being connected between each individual thermal sensor element (1′,1*) and the multiplexer (2).

10. An array for reading out electronic signals from high-resolution thermal sensors consisting of a plurality of thermal sensor elements, multiplexers and amplifiers, the signals of a plurality of sensor elements being in each case serially read out by means of one multiplexer via one or a few data lines, characterized in that an amplifier each is connected in each case between each individual sensor element and the multiplexer.

11. The array for reading out electronic signals according to claim 10, characterized in that means are present in the circuit by means of which the amplifiers can be optionally cyclically switched on and switched off in order to reduce the thermal load.

12. The array for reading out electronic signals according to claim 10 or 11, characterized in that the amplifiers are operational amplifiers.

13. The array for reading out electronic signals according to claim 10 or 11, characterized in that the amplifiers are differential amplifiers.

14. The array for reading out electronic signals according to claim 10 or 11, characterized in that the amplifiers are impedance converters.

15. The array for reading out electronic signals according to claim 10 or 11, characterized in that the circuit array is manufactured in an integrated fashion in CMOS technology.
